(19) United States
(12) Patent Application Publication
(10) Pub. No.: US 2005/0254648 A1
(43) Pub. Date: Nov. 17, 2005

(54) Conditional access data decrypting system

(75) Inventors: Sylvain-Victor Nahum, Geneve (CH); Philippe Stransky, Cheseaux-sur-Lausanne (CH)

Correspondence Address: HARNESS, DICKEY & PIERCE, P.L.C., P.O. BOX 8910, RESTON, VA, 20195, US

(73) Assignee: Nagravision S.A., Cheseaux-sur-Lausanne (CH)

(21) Appl. No.: 10/528,788

(22) PCT Filed: Sep. 19, 2003
(86) PCT No.: PCT/IB03/04121

§ 371 Date: Mar. 23, 2005

(30) Foreign Application Priority Data
Sep. 27, 2002 (CH) 2002 1623/02
Dec. 4, 2002 (CH) 2002 2048/02

(51) Int. Cl. H04N 7/167

(52) U.S. Cl. 380/201

(57) ABSTRACT

This invention relates to a conditional access data decryption system, in particular used in the domain of digital pay television.

This system includes a diffusion centre (10) arranged to diffuse data encrypted by control-words (cw), at least one management centre (11) arranged to diffuse personal messages (ECM, EMM) related to the management of access means to encrypted data, an operating device (12) intended to render usable said encrypted data, and a decoder (13) arranged to decrypt at least one part of the encrypted data. This decoder is placed between the diffusion centre (10) and the operating device (12). This decoder (13) comprises a module (14) for the reception and decryption of encrypted data and a module (15) for the management of access rights to this data. The reception module (14) is connected or integrated into the operating device (12) and the management module (15) is arranged to communicate with the reception module. The management module (15) includes a security module (16) arranged to verify the content of the personal messages (ECM, EMM) and to allow or prevent the decryption of the control words (cw) according to the content of the personal messages. The reception module receives the encrypted data originating from the diffusion centre (10) and the management module receives the authorization messages (EMM) from the management centre (11).

This invention relates to a conditional access data decryption system.

These types of systems are used in particular in the field of digital pay television. In this case, the digital data stream transmitted towards the television is encrypted in order to be able to control the use and define the conditions for this type of use. This enciphering is achieved thanks to Control Words that are changed at a regular interval (typically between 5 and 30 seconds, although notably longer intervals may be used) in order to dissuade any attack aiming to discover this control word.

In order for the receiver to be able to decrypt the encrypted stream with these control-words, the latter are sent independently of the stream in control messages (ECM) encrypted by a key pertaining to the transmission system between a management centre and a security module of the user unit. In fact, the security operations are carried out in a security module (SC) that is generally in the form of a smart card, reputed to be inviolable. This module can be either of the removable type or can be directly integrated into the receiver.

At the time of the decryption of a control message (ECM), it is verified, in the security module (SC), that the right to access the stream is present. This right can be managed by authorization messages (EMM) that load this right into the security module. Other possibilities are also imaginable such as the sending of decryption keys.

In the following, “event” refers to video or audio (for example MP3) content or data (game programme, for example) which is encrypted according to the known method of control-words, each event being able to be encrypted by one or more control-words, each having a determined validity duration.

Accounting for the use of such events is today based on the principle of subscription, on the purchase of events or on payment by time unit.

Subscription allows the definition of a right associated to one or more diffusion channels transmitting these events and allows the user to obtain these channels in plaintext if the right is present in his/her security module.

Likewise, it is possible to define the rights for an event, such as a film or a football match. The user can acquire this right (purchase, for example) and this event will be managed specifically by this right. This method is known under the denomination “pay-per-view” (PPV).

With regard to payment by time unit, the security module includes a credit that is debited according to the actual consumption of the user. Therefore, for example, a unit will be debited each minute to this credit regardless of the channel or the event in question. It is possible, according to the technical implementations, to vary the accounting unit, either in duration or in the value of time allocated, or even by combining these two parameters to adapt the invoice to the type of event transmitted.

A control message (ECM) does not only contain the control word but also the conditions required for this control word to be sent back to the receiver/decoder. At the time of the decryption of control words, it will be verified if a right associated to the access conditions given in the message is present in the security module.

The control word is only returned to the user unit when the comparison is positive. This control word is contained in a control message ECM that is encrypted by a transmission key.

In order for the right to be present in the security module, it is generally loaded into this module by an authorization message (EMM) which for security reasons, is generally encrypted by a different key, called right key (RK).

According to a known form of Pay-TV diffusion, the three following elements are necessary to decrypt an event at a given time:
the data related to the event encrypted by one or a plurality of control-words (CW),
the control message(s) ECM containing the control-words (CW) and the access conditions (AC)
the corresponding right stored in the security module allowing the verification of said access conditions.

The decryption systems of the type described above are presently all made up of relatively large equipment. They are linked to an operating or visualization device such as, for example, a television by means of a cable. They are not provided to be able to be moved easily. Therefore, it is not possible to move one's own decoder and simply connect it to another television and acquire punctual rights. Furthermore, in the present systems, relatively few installations have a return line allowing communication from the decoder towards a management centre. The installations that have a return line do not generally have an interface allowing user-friendly communication with this management centre. In fact, the return lines are provided for communication between the decoder and the management centre, but not between the user and this centre. It is therefore difficult to acquire punctual rights simply and rapidly. Furthermore, in all the known systems, the streams containing the data, the control messages and the authorization messages originate from a unique source that manages its own subscriptions, without being able to offer a range of subscriptions from different sources.

Communication with a management centre has been improved in systems allowing the loading of punctual rights. This type of system is described in the U.S. Pat. No. 5,901,339. This document describes a system including several diffusion centres for data or encrypted events, intended to transmit these events to an operating system such as a television or other display means. These events are associated on one hand to a unique identification number and on the other hand to a decryption code. The system also includes a loading centre to which are transmitted, before the diffusion of the events, the identification number of each event, associated to the decryption code. When a user wishes to acquire rights to decrypt an encrypted event, he/she calls the loading centre by means of a communication apparatus such as a telephone and indicates the identification number of the event that he/she wishes to acquire. The loading centre transmits the decryption code of the event in question to the communication apparatus. In turn, the loading apparatus transmits this code to the decoder of the user. When the event is broadcasted, the decoder has the decryption code and the event can be decrypted and visualized.

This system involves a certain number of constraints. In particular, as the decryption code is received on user's request, it is inconvenient to use several codes for the same event. This code must remain the same for the entire duration of this event. This presents a drawback from the point of view of security. As a comparison, in the present systems, the control-words used for the enciphering and decryption of events are changed at intervals that can vary from approximately 2 to 30 seconds.

In the system according to U.S. Pat. No. 5,901,339, several diffusion centres are connected to only one loading centre. This implies, in particular, that all the diffusers must place their cryptographic means in the same loading centre, which is not an optimal situation with respect to security.

This system also presents other shortcomings related to security. On one hand, the transmission of the decryption code between the loading centre and the user's decoder is carried out by means of a telephone line via a telephone without security means. This implies that it is relatively easy to obtain this code illegally and use it in combination with another decoder. On the other hand, as the loading centre does not dispose of any information relating to the decoder requesting the decryption code, it is possible to use this code on any decoder. This means that once it has been acquired legally, the decryption code can easily be transmitted to other decoders to decrypt an event or data illegally.

The document “EBU Technical Review” Winter 1995 No. 266 entitled “Functional model of a conditional access system” describes different variables of conditional access systems intended in particular for Pay-TV, these systems use two-level decryption, namely first level security by means of control messages ECM and a second level using authorization messages EMM. In one of these variants, the conditional access system is intended to be used simultaneously by several conditional access data diffusers. The system as described includes, in particular, a right management system, responsible for generating and sending the authorization messages EMM and an authorization management system responsible for generating control-words for enciphering the diffuser data.

In all the examples represented and described in this document, each diffuser is associated univocally to a right management system. It is not possible to associate only one diffuser to several right management systems. In the system according to this document, the use of one or more service providers is totally transparent for the user. In fact, the latter cannot choose one operator or another, he/she can only choose a service that has one or more operators.

This system does not solve the problems connected to the simple displacement of the decoder and to the acquirement of punctual rights, nor the problem of communication between the user and the management centre.

This invention intends to avoid the drawbacks of the systems in the prior art and produce a system that can easily be displaced and used on practically any adapted operating device. Furthermore, this type of system simplifies the management of the access rights at the level of the diffusion centre and offers greater flexibility to the user by guaranteeing optimal security so that the data obtained by a user and intended for a determined decoder cannot be used on another decoder.

These aims are achieved by a conditional access data decryption system, this system implementing:
a diffusion centre arranged to diffuse data encrypted by at least one control word, at least one management centre arranged to diffuse personal messages related to the management of the access means to encrypted data,
an operating device intended to render usable said encrypted data, and
a decoder arranged to decrypt at least one part of the encrypted data, placed between the diffusion centre and the operating device,
   characterized in that
the decoder comprises a module for the reception and decryption of encrypted data and of a module for the management of access rights to this data, these modules being physically different, the reception module being connected to the operating device and the management module being arranged to communicate with the reception module,
the management module includes a security module comprising a unique identification number and data allowing securing the connection between said management centre and the security module, this security module being arranged to verify the content of the personal messages and to allow or prevent the decryption of the control-word(s) according to the contents of the personal messages,
and in that the reception module receives the encrypted data originating from the diffusion centre via a first communication line, and the management module receives the personal messages through the management centre via a second communication line.

This invention and its advantages will be better understood with reference to the description of different embodiments and enclosed drawings, in which:

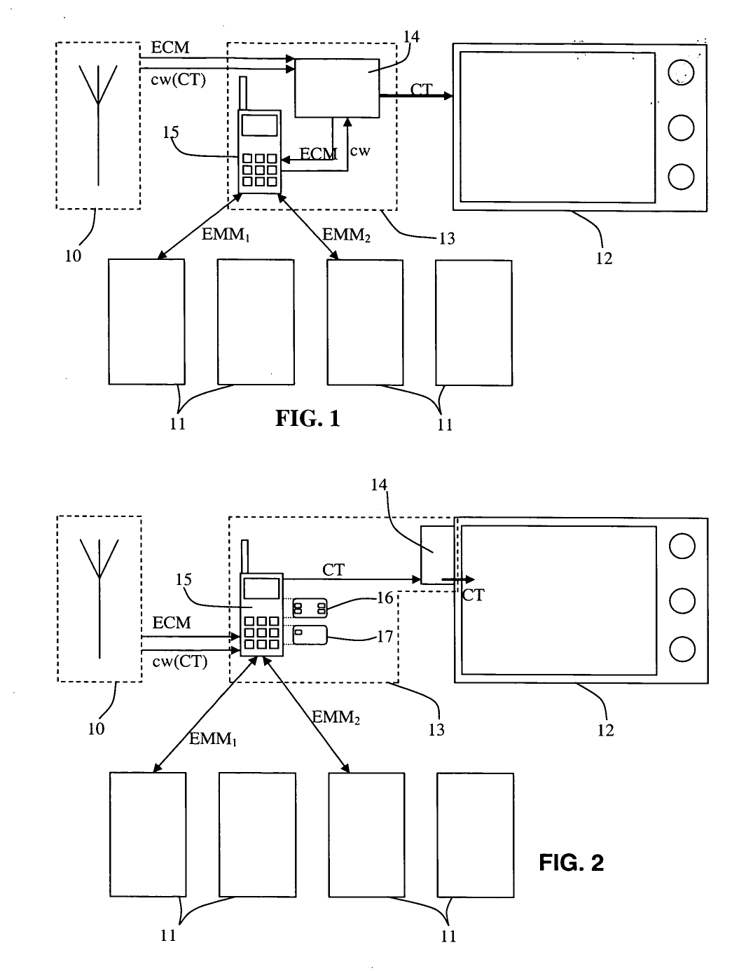

FIG. 1 represents an overall view of a first embodiment of the system according to this invention; and

FIG. 2 is an overall view of a second embodiment of the invention.

With reference to these Figures, the system relating to this invention essentially includes a diffusion centre 10 arranged to diffuse encrypted data, at least one management centre 11 arranged to diffuse authorization messages (EMM) and process the management of access rights to encrypted data, an operating device 12 intended to render usable this encrypted data and a decoder 13 arranged to decrypt at least one part of the encrypted data.

The diffusion centre 10 for encrypted data can be a classic device using cables or, in particular satellite. This centre transmits data in the encrypted form. The nature of this data depends, of course, on the way in which it must be used. In the following, it is understood that the data is used in a conditional access television system. The data is thus made up of video contents CT, that is to say of images and sound. Other data specific to this particular use can also be included, as is well known to those skilled in the art. This data, or at least one part of it, is encrypted by means of control-words and are noted as cw (CT) in the Figures.

According to a first embodiment, the control-words cw are transmitted, in an encrypted form, by the diffusion centre at the same time as the encrypted data. According to another embodiment, these control-words can be diffused by the management centre 11 as the encryption of the control message, comprising the control word, is specifically managed according to a protocol pertaining to each management centre.

The denomination “personal message” represents an authorization message (EMM) in the case where the control messages (ECM) are not specific, these personal messages allowing access to the data by the storage of a right. The control word is extracted from this message and sent to the reception module generally in the encrypted form, so that the control-words cannot be copied at this level and sent to another user.

The management centre or more generally the management centres 11 are responsible for managing the access rights to the data. They can each manage different types of rights, in particular subscriptions, punctual access, different channel combinations. In order to achieve this, they also diffuse the corresponding authorization messages (EMM) intended for the decoders in question.

The operating device 12 is also, of course, adapted to the data to be transmitted. In the chosen case of conditional access television, the operating device is a television.

The decoder 13 includes a module 14 for the reception and decryption of the data and a module 15 for the management of the rights to access to this data. The right management module is produced in such a way that it is easily movable. It can judiciously be made by means of a mobile telephone. The management module also includes a security module 16. This reception and decryption module can comprise standardized communication means with the management module. Therefore, the reception module is capable of interacting with any management module.

A developed security module can comprise storage areas pertaining to each management centre. In the case of a mobile telephone, the telephony operator can allocate storage areas that will be then activated by parameters for each management centre. These parameters are, for example, a decryption key of authorization messages (EMM), the identification of the subscriber according to the system pertaining to said management centre, or even a credit.

In the case that different operators do not wish to integrate their security into a common module or simply to increase the flexibility of use, it is possible to provide connector technology that allows the security module either to be changed easily, or for several to be used at a time. These modules can be produced in the form of a smart card cooperating with an appropriate reader of the management module or in a more compact form allowing the implementation of several security modules simultaneously. In this case, each chip manages the authorizations originating from one of the management centres.

It is also possible to provide a card or another support including several chips, each of them managing authorizations originating from one of the management centres. This type of security module is disclosed in FIG. 2, under the reference 16.

The security module, or each of the modules when there are several, contains a unique identification number (UA) and data pertaining to the management centres 11 with which these modules are authorized to communicate. This means that before being able to obtain and decrypt an authorization message (EMM) originating from a management centre, the data related to this management centre must first have been loaded into the security module. The data pertaining to the management centre is, for example, an enciphering key or a code allowing the formation of an enciphering key, this data allowing the connection between the management centre and the security module to be secured. According to one advantageous embodiment, the authorization messages EMM are sent to the security module in an encrypted form by means of a key which depends both on the related management centre and on the unique identification number UA of this security module. In this way, an authorization message received by a security module cannot be used by another module. Furthermore, a falsified module not containing the data pertaining to the management centre cannot use the authorization message since it is incapable of decrypting said message.

The management module 15 advantageously includes a smart card reader intended to be used with a credit card or a prepayment card 17. In this way, the management of the payment is assured when an event is requested. Furthermore, this allows the use of the management module as an electronic purse. This type of card is shown under the reference 17 in FIG. 2.

According to one embodiment that implements several management centres for data diffused towards the reception module, provision is made to add descriptive information to said encrypted data in order to allow the user to connect with the appropriate management centre. This descriptive information is transmitted from the reception module towards the managing module and displayed on said module. The user can make his/her choice and initiate a communication with a centre, as long as his/her security module supports the security functions required by this management centre. This descriptive information, in addition to describing the video or audio product, comprises a telephone or Internet type address. This address will be used for interaction in order to send the personal message allowing the reception of the rights or the keys necessary for access to encrypted data.

The reception and decryption module 14 of the data can be directly integrated into the television apparatus 12. In this case, in order to be able to read encrypted data on this type of television, it is sufficient to have the management module 15 and the rights corresponding to the desired event. This event can thus be visualized from any adequately equipped television set. This embodiment is schematically illustrated in FIG. 2. According to another advantageous embodiment, it can be made up of a casing that can be connected to the television by means of a connection cable or directly by an outlet on the television. This allows the simple use of this invention on existing televisions.

The system according to the invention operates in the following way:

As mentioned previously, the video content CT is diffused by the diffusion centre 10 of encrypted data. Simultaneously, this first centre also diffuses the control-word(s) cw that has been used to encipher the data. When a user wishes to use data of the conditional access system, for example, to see an event such as a film or a football match for example, for which access is subject to a right, it is first necessary to acquire this right. The latter can be given by a pre-payment card in the management module 15, or it can be loaded into this module thanks to communication means between the module and one of the management centres 11, which manages the access rights.

In order to obtain the authorization messages EMM which will allow the decryption of the control words cw necessary for the decryption of the data and then the visualization of the event, the reception and decryption module 14 establishes a communication with one of the management centres. As previously mentioned, the reception module can be a mobile telephone. In this case, contact is established by dialling a telephone number corresponding to the diffusion centre. The choice of the event for which the user wishes to acquire the rights is made by means of a pre-recorded “menu”, each option of the menu relating to a particular number on the keypad of the mobile telephone. The downloading of the authorization message corresponding to the event chosen is carried out after having pressed a validation key on the keypad of the telephone. This authorization message is advantageously encrypted by means of a key depending both on the unique identification number UA of the security module and on the data pertaining to the management centre.

The reception and decryption module 14 is connected to the television, for example, on an outlet of the latter or directly integrated into the television.

In a first embodiment, the reception module 14 receives, originating from the first diffusion device 10, the encrypted data cw (CT) by means of control-words as well as the control-words cw themselves. It also receives the authorization messages EMM originating from one of the management centres 11. The reception module 14 transmits the control-words cw to the right management module. This transmission can be carried out by means of infrared or radio waves, for example. This right management module verifies that the rights corresponding to the event chosen have been acquired correctly. If this is the case, the control messages ECM are processed in the security module in such a way as to extract the control-words cw. The latter are then transmitted, at an adequate frequency corresponding to the frequency used for the encryption of the data, to the reception module 14 that then uses said control-words to decrypt the data and thus render the event visible.

In a second embodiment, schematically illustrated in FIG. 2, the stream containing the encrypted data, the control messages and the authorization messages is received by the rights management device 15. These streams are processed as previously and the decrypted data is transmitted in plaintext to the reception device.

This system allows the production of a decoder that is easily transportable and that can be used on any television. In the case where the data reception module 14 is integrated into the television set, it is sufficient to dispose of the management module 15 to have access to an event. In this way, the constraints for users are eliminated. Furthermore, the fact that management centres are used for authorization messages that are different from the data diffusion centre increases the choice offered to the user and facilitates the use of conditional access systems.

Since control-words are decrypted in the management module and transmitted towards the reception module, the communication between these two modules will preferably be secured. For this, there are different pairing procedures usually adapted to the pair formed by the security unit and the decoder. In this case, these procedures are applied between the reception module and the management module. An example of this type of pairing is described in application WO 02/052515.

In order to guarantee that the control-words are not disseminated towards other reception and decryption modules, and in a diagram with two levels, that is to say when the control message is of the personal type, the management centre can demand an encryption key pertaining to the decryption module. This key is directly encoded in the decryption module and is unique for each module.

In the case where the control messages ECM containing the control-words cw are sent through the management centre or in the similar case where an event is encrypted by means of one single key which is sent to the security module by a management centre, this management centre applies, on a given control word, an encryption pertaining to the unique key of the decryption module, then an encryption pertaining to the telecommunications system between the management centre and the security module to the security module of the management module. Therefore, if this message were intercepted by a falsified security module, the control word obtained would be unusable for another decryption module as it remains encrypted by the unique key of this module.

According to one embodiment, the connection between the management module and the management centre is a secured point to point connection. It is therefore possible to transmit commands in relation to the images and events diffused by the diffusion centre. This function is used to make commands via the management module or responses to questions.

In one application, the images diffused towards the decoder are real images originating from casino games such as roulette or black jack and the owner of this type of management module can play interactively and in real time, wherever he/she is. The security means implemented for the conditional access to broadcasted data can also be used for this type of application. In this type of application, the casino is linked to the management centre in order to determine the identity of the carrier of the management module or at the very least that this carrier is solvent. The management centre allocates a credit to this carrier and communicates this information to the casino.

1. Conditional access data decryption system, this system comprising:
a diffusion centre arranged to diffuse data encrypted by at least one control word,
at least one management centre arranged to diffuse personal messages related to the management of access means to encrypted data,
an operating device intended to render usable said encrypted data, and
a decoder (arranged to decrypt at least one part of the encrypted data, placed between the diffusion centre (and the operating device, and comprising
a module for the reception and decryption of encrypted data, and
a module for the management of access rights to this data, these modules being physically different, the reception module being connected to the operating device and the management module being arranged to communicate with the reception module,
the management module including a security module comprising a unique identification number and data allowing securing the connection between said management centre and the security module, the security module being arranged to verify the content of the personal messages IC and to allow or prevent the decryption of the control-word(s) according to the content of the personal messages, wherein
the reception module receives the encrypted data originating from the diffusion centre via a first communication line, and the management module receives the personal messages through the management centre via a second communication line, and wherein the management module comprises data pertaining to the management centres with which these modules are authorized to communicate.

2. Data decryption system according to claim 1, wherein the communication between the reception module and the management module (is a communication by means of waves.

3. Data decryption system according to claim 1, wherein the rights management module is a mobile telephone.

4. Data decryption system according to claim 3, wherein the security module includes identification functions necessary for telephony and at least one storage area pertaining to a management centre, this area comprising the security parameters for reception of the authorization messages of said management centre.

5. System according to claims 1, wherein the diffusion centre is arranged to diffuse control messages comprising the control-word(s), and wherein the personal messages broadcasted by the management centre correspond to an authorization message.

6. System according to claims 1, wherein in that the management centre is arranged to diffuse personal messages comprising the control-word(s), the security module of the management module having means for determine if the message is intended for said security module and means for transmits the control word to the reception module.

7. System according to claim 6, wherein the reception and decryption module includes a unique decryption key applied to the control word (cw), the key serving to encrypt the control-words at the management centre before their transmission towards the management module.

8. Data decryption system according to claim 1, including at least two management centres, wherein the security module of the managing module includes security parameters for the reception of the authorization messages originating from different management centres.

9. Data decryption system according to claims 1, the diffusion centre being arranged to transmit descriptive information of the encrypted data, wherein the data contains indications necessary for the establishment of communication with the management centre that is responsible for the authorization of the data, and is transmitted to the management module, the latter being arranged to establish communication with the management centre in question to obtain the authorization message.

10. Data decryption system according to claim 1, wherein the reception and decryption module is integrated into the operating device.

11. Data decryption system according to claim 1, wherein the reception and decryption module includes standardized communication means with the management module, for permitting interaction between a reception and decryption module and a plurality of management modules.

12. Data decryption system according to claim 1, wherein the management module includes means for establishing a matching key with the reception module, the key being intended to encrypt and decrypt at least the control-word(s) transmitted to the management module towards the reception module.

13. System according to claim 2, wherein the diffusion centre is arranged to diffuse control messages comprising the control-word(s), and wherein the personal messages broadcasted by the management centre correspond to an authorization message.

14. System according to claim 2, wherein the management centre is arranged to diffuse personal messages comprising the control-word(s), the security module of the management module having means for determining if the message is intended for said security module and means for transmitting the control word to the reception module.

15. System according to claim 3, wherein the diffusion centre is arranged to diffuse control messages comprising the control-word(s), and wherein the personal messages broadcasted by the management centre correspond to an authorization message.

16. System according to claim 3, wherein the management centre is arranged to diffuse personal messages comprising the control-word(s), the security module of the management module having means for determining if the message is intended for said security module and means for transmitting the control word to the reception module.

17. System according to claim 4, wherein the diffusion centre is arranged to diffuse control messages comprising the control-word(s), and wherein the personal messages broadcasted by the management centre correspond to an authorization message.

18. System according to claim 4, wherein the management centre is arranged to diffuse personal messages comprising the control-word(s), the security module of the management module having means for determining if the message is intended for said security module and means for transmitting the control word to the reception module.

19. Data decryption system according to claim 2, wherein the reception and decryption module is integrated into the operating device.

20. Data decryption system according to claim 2, wherein the management module includes means for establishing a matching key with the reception module, the key being intended to encrypt and decrypt at least the control-word(s) transmitted to the management module towards the reception module.
